(19) United States
(12) Patent Application Publication
(10) Pub. No.: US 2007/0209531 A1
(43) Pub. Date: Sep. 13, 2007

(54) Hydraulic Press With A Displacable Platen

(76) Inventor: Jan Hubbe, Huskvarna (SE)

Correspondence Address: DAVIS & BUJOLD, P.L.L.C., 112 PLEASANT STREET, CONCORD, NH, 03301, US

(21) Appl. No.: 11/547,404

(22) PCT Filed: Mar. 24, 2005
(86) PCT No.: PCT/SE05/00432

§ 371 Date: Oct. 2, 2006

(30) Foreign Application Priority Data
Apr. 7, 2004 (SE) 0400919-7

(51) Int. Cl. B30B 1/00

(52) U.S. Cl. 100/226

(57) ABSTRACT

A hydraulic press is provided with a first plate (1), a second plate (2), parallel to the first plate, and at least one hydraulic cylinder unit (11), designed to be able to displace the plates (1, 2) in relation to each other in a direction perpendicular to the plates, in order move the plates (1, 2) towards each other from an initial pressing position into a pressing position in order to mould a body (10), placed between the plates (1, 2), with a high pressure, and then away from each other into the initial pressing position, when the moulding of the body (10) has been concluded. A hydraulic cylinder unit (5) is designed to be able to displace the two plates (1, 2) in relation to each other between the initial pressing position, in which the plates (1, 2) are placed adjacent each other, and a starting position, in which the plates (1, 2) are placed at a greater distance from each other.

This application is a national stage completion of PCT/SE2005/000432 filed Mar. 24, 2005 which claims priority from Swedish Application Serial No. 0400919-7 filed Apr. 7, 2004.

### THE TECHNICAL FIELD

The present invention relates to a hydraulic press, which comprises a first plate, a second plate, parallel to the first plate and at least one hydraulic cylinder unit, which is designed to displace said plates in relation to each other in a direction, which is perpendicular to said plates, in order to move the plates towards each other from an initial pressing position to a pressing position for moulding a body, placed between said plates, with high pressure and then away from each other and back to the initial pressing position, when the moulding of the body has been concluded.

### THE BACKGROUND OF THE INVENTION

Known hydraulic presses of this type are utilized i.a. as sinter presses, designed to compress with high pressure a body of a metallic powder, a ceramic powder or a mixture thereof into a desired shape in order to produce an object, e.g. a gear wheel.

In the known sinter presses the two plates are horizontal, one of the plates being a lower stationary plate and the other plate being an upper, displaceable plate. The hydraulic cylinder unit is mounted above the displaceable plate and its piston rod is attached to it.

When the piston rod is moved to its projected position, the upper plate is moved towards the lower plate in order to exert a very large pressing force on a powder body, placed on the lower plate, and to mould it to the desired shape.

In the initial pressing position the distance between the upper plate and the lower plate must be relatively large in order to allow a substantial space, to be able to insert the body to be moulded and to remove the moulded body. The distance between the plates is in the initial pressing position normally about 300 mm. The two plates must then consequently, in order to be able to mould the body, be displaced about 300 mm in relation to each other from the initial pressing position to the pressing position. In case the hydraulic cylinder unit has very large dimensions in order to provide pressing forces of about 600-800 kN, large amounts of hydraulic oil must consequently be displaced in the hydraulic system in order to be able to move the plates the required distance, which will make the press relatively slow.

For sinter presses, and also for other types of hydraulic presses, a high production speed is aimed at, i.e. the press must be able to move the plates with a high speed in order to obtain short cycles of operation.

### SUMMARY OF THE INVENTION

The object of the present invention is to provide a hydraulic press having a high production speed but which will nevertheless be able to perform with large pressing forces.

This object will be attained according to the present invention by means of a hydraulic press, which is designed in the way described in the introduction and is characterized in that a hydraulic cylinder unit is designed and mounted to be able to move the two plates in relation to each other between the initial pressing position, in which the plates are placed adjacent each other, and a starting position, in which the plates are placed at a greater distance from each other.

Thanks to this arrangement the hydraulic press will be fast, since the distance between the plates is small in the initial pressing position. A space allowing the insertion of the body to be moulded as well as allowing the removal of the moulded body is provided by moving the plates to the starting position by means of the hydraulic cylinder unit, which will be dimensioned just to take care of this displacement, since it does not have to provide any pressing force. The hydraulic press preferably is designed in such a way, that the first plate is a stationary plate and the second plate is a displaceable plate, the hydraulic cylinder unit being designed to be able to displace the movable plate between the starting position and the initial pressing position.

In a preferred embodiment the movable plate is subdivided into a first plate element and a second plate element, parallel to said first plate element, which is placed between the first plate element and the stationary plate, the hydraulic cylinder unit being designed and mounted to be able to displace the lower plate element between the initial pressing position and the starting position, a locking device being designed to lock the two plate elements in relation to each other, when the second plate element is in the initial pressing position, and the hydraulic cylinder unit being designed to be able to, via the first plate element, move the second plate element from the initial pressing position into the pressing position for a moulding of the body.

### A BRIEF DESCRIPTION OF THE DRAWINGS

The present invention will now be described in more detail by means of a preferred embodiment, reference being made to the accompanying drawings:

FIG. 1 is a lateral view, showing schematically and partly in section a hydraulic press according to the invention in a starting position.

FIG. 2 is a lateral view, showing schematically and partly in section the hydraulic press according to FIG. 1 in an initial pressing position.

### DETAILED DESCRIPTION OF A PREFERRED EMBODIMENT

The hydraulic press, shown in the drawings, is a sinter press and is provided with a stationary horizontal lower plate 1 and a movably mounted horizontal upper plate 2. Upper plate 2 is subdivided into a movably mounted horizontal upper plate element 2a and a movably mounted horizontal lower plate element 2b. A hydraulic cylinder unit 5 is mounted above upper plate element 2a, which unit is provided with a cylinder 6, a piston (not shown) and a piston rod (not shown). Cylinder 6 is rigidly attached to upper plate element 2a, and the piston rod is freely movable through upper plate element 2a towards lower plate element 2b and is rigidly attached to the same.

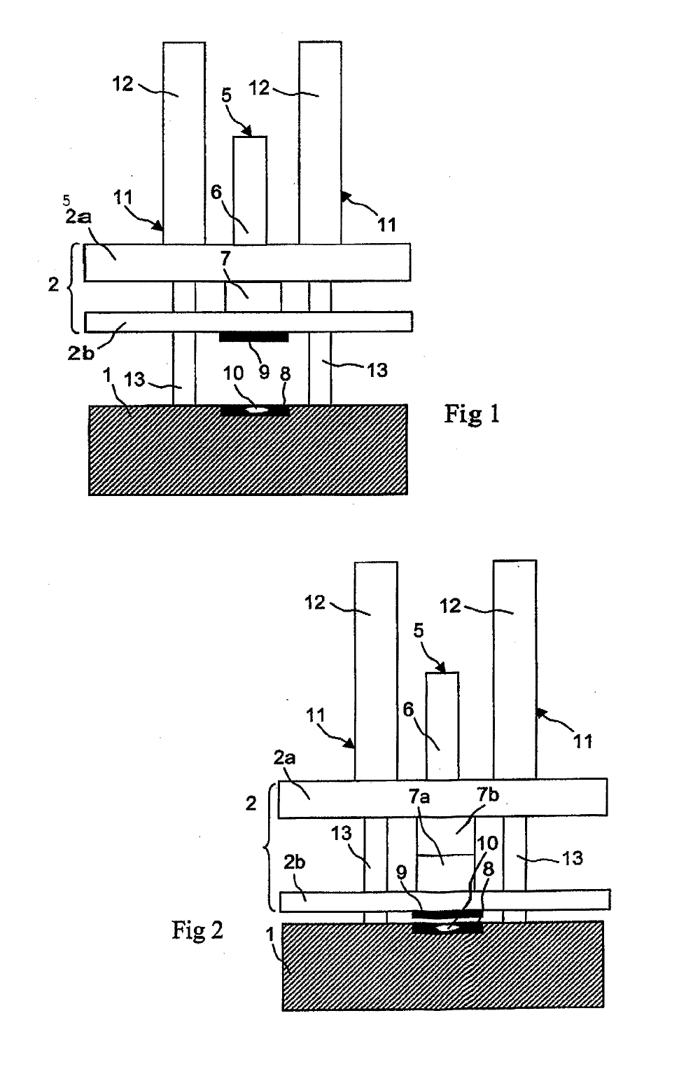

A locking device 7 is mounted between upper plate element 2a and lower plate element 2b. Locking device 7 comprises two telescopically displaceable parts 7a,7b and is designed to be inserted into the position, shown in FIG. 1 and in which the two parts are inserted into each other, and to be pushed outwards into the position, shown in FIG. 2 and in which said parts are pushed outwards from each other and are turnable in relation to each other into a position, in which a telescopic folding of the parts will be prevented.

Lower plate 1 supports a moulding tool 8, and lower plate element 2b carries a moulding tool 9, which will interact with moulding tool 8 to mould an object from a body 10, positioned in moulding tool 8 and made of e.g. a metallic powder, a ceramic powder or a mixture of a metallic and a ceramic powder.

Also, the hydraulic press is provided with two hydraulic cylinder units 11, each one being provided with a cylinder 12, a piston (not shown) and a piston rod 13. Cylinder 12 is disposed above upper plate element 2a and rigidly attached to the same. Piston rod 13 is freely movable through upper plate element 2a and lower plate element 2b up to stationary plate 1 and is rigidly attached to the same.

When body 10, placed between stationary plate 1 and movable lower plate element 2b, is to be moulded, initially the piston rod of first hydraulic cylinder unit 5 is pushed outwards and at the same time extends through locking device 7, into a projected position in order to move lower plate element 2b from its starting position, which is shown in FIG. 1, in a direction from upper plate element 2a towards lower plate 1 into an initial pressing position, which is shown in FIG. 2 and in which lower plate element 2b and stationary plate 1 are positioned adjacent each other.

When lower plate element 2b is in its initial pressing position (FIG. 2), locking device 7 is in its projected position, in which its two parts 7a, 7b, in a way not shown in detail, are turned in relation to each other, into the locking position in order to lock lower plate element 2b in relation to upper plate element 2a. Then lower plate element 2b is moved a short distance from its initial pressing position towards lower plate 1 into a pressing position by pulling piston rods 13 of hydraulic cylinder units 11 a short distance into cylinders 12, upper plate element 2a via locking device 7 moving lower plate element 2b downwards towards stationary plate 1 with a very strong force. In the pressing position body 10, placed between stationary plate 1 and lower plate element 2b, will then be moulded into the desired shape.

As is obvious from the description above, it is only necessary to let hydraulic cylinder units 11, which are dimensioned to be able to exert large pressing forces, move plate 2, which comprises the two plate elements 2a and 2b, a short distance, i.e. between the initial pressing position and the pressing position. This means, that the pressing process per se takes a short time. Also, the movement, carried out by hydraulic cylinder unit 5, of lower plate element 2b between the initial pressing position and the starting position, which will provide space, required to insert body 10 to be moulded in the press and to remove the moulded body from the press respectively, will be carried out quickly, since the hydraulic cylinder unit is not required to exert a large pressing force and consequently is dimensioned to solely carry out this movement. Thus, these effects jointly will give the hydraulic press a high production speed and will make it able to use large pressing forces.

The hydraulic press according to the present invention can be modified in several ways within the scope of the inventive idea, as it is defined in the following claims.

1. A hydraulic press, which comprises a stationary plate (1), a movable plate (2), parallel to said first plate and at least one hydraulic cylinder unit (11), designed and mounted to displace the plates (1, 2) in relation to each other in a direction, which is perpendicular to the plates, in order to move the plates (1, 2) towards each other from an initial pressing position to a pressing position to be able to mould a body (10), placed between the plates (1, 2), with a high pressure and then away from each other into the initial pressing position, when the moulding of the body (10) has been concluded, characterized in that a hydraulic cylinder unit (5) is designed and mounted to displace the movable plate (2) between the initial pressing position, in which the plates (1, 2) are placed adjacent each other, and a starting position, in which the plates (1, 2) are placed at a larger distance from each other.

2. A hydraulic press according to claim 1, wherein the movable plate (2) is subdivided into a first plate element (2a) and a secondary plate element (2b), parallel to said first plate element, which second plate element is positioned between said first plate element (2a) and the stationary element (1), the hydraulic cylinder unit (5) being designed to be able to move the secondary plate element (2b) between the initial pressing position and the starting position, the locking device (7) being designed to be able to lock the two plate elements (2a, 2b) in relation to each other, when the secondary plate element (2b) is positioned in the initial pressing position, and the hydraulic cylinder unit (11) being designed, via the first plate element (2a), to be able to displace the secondary plate element (2b) from the initial pressing position into the pressing position in order to mould the body (10).
